(19) United States
(12) Patent Application Publication
(10) Pub. No.: US 2021/0301361 A1
(43) Pub. Date: Sep. 30, 2021

(54) TOOL FOR A HYDRAULIC HAMMER

(71) Applicant: Caterpillar Inc., Peoria, IL (US)

(72) Inventors: Cody MOORE, Lorena, TX (US); Curtis A. HENNING, Dunlap, IL (US)

(73) Assignee: Caterpillar Inc., Peoria, IL (US)

(21) Appl. No.: 16/836,209

(22) Filed: Mar. 31, 2020

(51) Int. Cl. C21D 1/19; E02F 3/96; E02F 9/28

(52) U.S. Cl. CPC C21D 1/19; C21D 2261/00; E02F 9/285; E02F 3/966

(57) ABSTRACT

A tool for a machine implement is disclosed. The tool may include a hardened portion of a material and a softened portion of the material. The hardened portion may extend along and encompass a longitudinal axis of the tool between a base end and a tip end of the tool. The softened portion may extend along and be offset from the longitudinal axis of the tool between the base end and the tip end of the tool.

### TECHNICAL FIELD

The present disclosure relates generally to a tool and, for example, to a tool for a hydraulic hammer.

### BACKGROUND

Hydraulic hammers are used at various work sites for breaking up objects, such as rocks, concrete, asphalt, ground, and other materials. To penetrate the objects, the hydraulic hammers include tools having sharpened cutting edges, such as moil points, chisels, cutters, and wedges. Over time, repeated contact with the objects abrades away at the sharpened cutting edges, causing the tools to become dull and ineffective.

One attempt to maintain a sharpened cutting edge is disclosed in U.S. Pat. No. 3,308,859 that issued to Ehlen on Mar. 14, 1967 (“the '859 patent”). In particular, the '859 patent discloses a cutter tooth for a chain saw having a hard top surface and a hard side surface. From these surfaces there is a gradual transition of the hardness to the interior or core of the tooth. The tooth will thus have a wear pattern wherein the softer core material will abrade away as the cutter tooth comes in contact with abrasive material while the hard portion on the outer surfaces will maintain the cutting edge.

The tool of the present disclosure is directed to overcoming one or more of the problems set forth above.

### SUMMARY

A tool for a machine implement is disclosed. The tool includes a softened portion of a material and a hardened portion of the material. The hardened portion extends along and encompasses a longitudinal axis of the tool between a base end and a tip end of the tool. The softened portion extends along and is offset from a longitudinal axis of the tool between the base end and the tip end of the tool.

A method of manufacturing a tool for a machine implement is disclosed. The method includes performing a through hardening process on a workpiece to form a hardened workpiece. The method further includes performing a softening process on the hardened workpiece to form the tool that includes a hardened interior portion and a softened exterior portion.

A hammer implement for a machine is disclosed. The hammer implement includes a hammer driver and a replaceable tool that is to be driven by the hammer driver. The replaceable tool includes a softened exterior portion of a material and a hardened interior portion of the material. The hardened interior portion is coaxially aligned with the softened exterior portion and situated within the softened exterior portion between a base end and a tip end of the replaceable tool.

### BRIEF DESCRIPTION OF THE DRAWINGS

FIG. 1 is a diagram of an example machine that includes a hydraulic hammer with a tool.

FIG. 2 is an axial cross-sectional view of the tool according to one or more aspects of the present disclosure.

FIG. 3 is a radial cross-sectional view of the tool, taken along line A-A of FIG. 2.

FIG. 4 is a radial cross-sectional view of the tool, taken along line B-B of FIG. 2.

FIG. 5 is an axial cross-sectional view of the tool according to one or more aspects of the present disclosure.

FIG. 6 is a radial cross-sectional view of the tool, taken along line C-C of FIG. 5.

FIG. 7 is a radial cross-sectional view of the tool, taken along line D-D of FIG. 5.

FIG. 8 is a bottom view of the tool according to one or more aspects of the present disclosure.

FIG. 9 is a bottom view of the tool according to one or more aspects of the present disclosure.

FIG. 10 is a bottom view of the tool according to one or more aspects of the present disclosure.

FIG. 11 is a bottom view of the tool according to one or more aspects of the present disclosure.

FIG. 12 is a diagram of the tool in a first sharpened state.

FIG. 13 is a diagram of the tool in a second sharpened state.

FIG. 14 is a flowchart of an example method of manufacturing the tool.

### DETAILED DESCRIPTION

This disclosure relates to a tool. The tool has universal applicability to any machine or implement utilizing such a tool. The term “machine” may refer to any machine that performs an operation associated with an industry, such as mining, construction, farming, transportation, or another type of industry. Moreover, one or more implements may be connected to the machine.

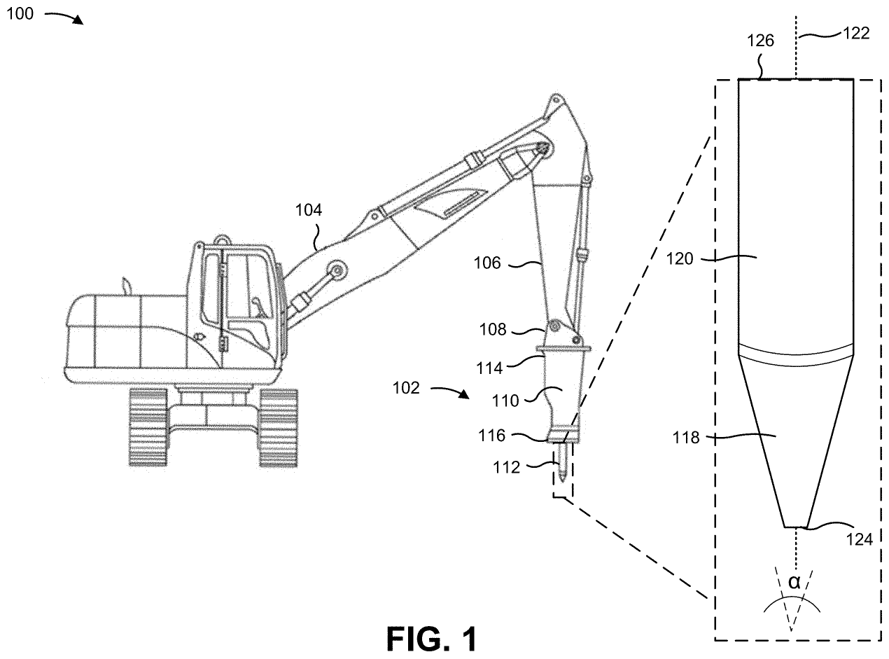

FIG. 1 is a diagram of an example machine 100 that includes a machine implement, such as a hydraulic hammer 102 (hereinafter referred to as “the hammer 102”). The machine 100 may be an excavator (shown in FIG. 1), a backhoe loader, a skid steer loader, or another type of machine. The machine 100 may perform work associated with a particular industry including, but not limited to, construction, mining, agriculture, waste management, material handling, or forestry.

The machine 100 includes linkages, such as a boom 104 and a stick 106. The stick 106 is pivotably connected to a mounting bracket 108, which is connected to the hammer 102. The hammer 102 includes a hammer driver 110 and a replaceable tool 112 (hereinafter referred to generally as “the tool 112”). A first end 114 of the hammer driver 110 is attached to the mounting bracket 108. A second end 116 of the hammer driver 110 is attached to the tool 112. The tool 112 is removably secured to the second end 116 of the hammer driver 110 via one or more retaining components (not shown). Thus, the tool 112 is capable of being detached from the hammer driver 110 and replaced with a different tool as needed. The tool 112 may be operated to break up or demolish an object, such as a rock, concrete, asphalt, ground, or another material. The tool 112 may include a tool capable of penetrating the object, such as a moil point, a chisel, a cutter, or a wedge.

As shown in an enlarged view in FIG. 1, the tool 112 includes a tip portion 118 and a base portion 120 that are coaxially aligned with a longitudinal axis 122. The tip portion 118 is tapered from the base portion 120 to a tip end 124 to define a taper angle α of the tip portion 118. The taper angle α may be in a range from approximately 10 degrees to approximately 50 degrees. In particular, the taper angle α may be approximately 30 degrees. The tip end 124 is configured to penetrate the object. The base portion 120 includes a base end 126 that is opposite from the tip end 124 and is configured to be removably attached to the second end 116 of the hammer driver 110.

As indicated above, FIG. 1 is provided as an example. Other examples may differ from what was described in connection with FIG. 1. For example, while the hammer 102 is described herein as working with the machine 100, in some implementations, the hammer 102 may work with another type of machine, such as a user-operated jackhammer. Furthermore, the tool 112, in some implementations, may be used independently from the hammer 102 or in combination with another device.

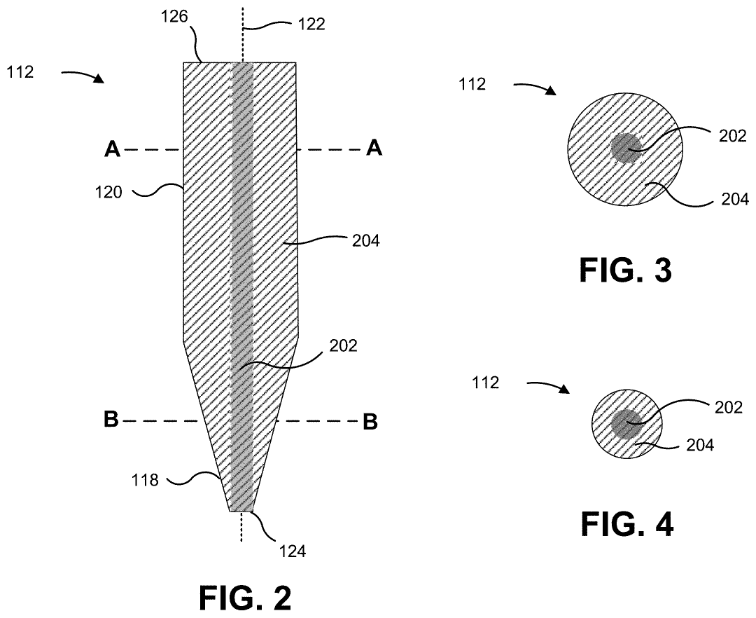

FIGS. 2-4 are diagrams of the tool 112 according to one or more aspects of the present disclosure. FIG. 2 is a diagram showing an axial cross-sectional view of the tool 112. FIG. 3 is a diagram showing a radial cross-sectional view of the tool 112, taken along line A-A of FIG. 2. FIG. 4 is a diagram showing a radial cross-sectional view of the tool 112, taken along line B-B of FIG. 2.

As shown in FIG. 2, the tool 112 is formed from a single, monolithic piece of material and is thus free from any additional layers or coatings. For example, the tool 112 may be made from a single, monolithic piece of steel or a similar metal. In order to maximize a strength of the tool 112, the tool 112 includes a hardened portion 202 that extends along and encompasses the longitudinal axis 122. The hardened portion 202 extends from the base end 126 of the tool 112 to the tip end 124 of the tool 112. The tool 112 further includes, exterior to the hardened portion 202 and coaxially aligned therewith, a softened portion 204. The softened portion 204 encompasses the hardened portion 202 from the base end 126 of the tool 112 to the tip end 124 of the tool 112 to enable the tip end 124 to remain sharp, as will be described in more detail below.

The softened portion 204 has a hardness that is less than a hardness of the hardened portion 202. For example, the hardness of the softened portion 204 may be in a range from approximately 28 HRC to approximately 32 HRC on the Rockwell scale. In particular, the hardness of the softened portion may be approximately 30 HRC on the Rockwell scale. The hardness of the hardened portion 202 may be in a range from approximately 44 HRC to approximately 55 HRC on the Rockwell scale. In particular, the hardness of the hardened portion 202 may be approximately 50 HRC on the Rockwell scale. To create a preferential wear pattern, which will be described in more detail below, the softened portion 204 and the hardened portion 202 may together define a hardness gradient, such that an exterior of the tool 112 is softer than an interior of the tool 112. In some implementations, the softened portion 204 alone may define the hardness gradient.

As shown by FIG. 3, a cross-section of the base portion 120 is substantially circular. Thus, the base portion 120 is a substantially cylindrical structure that is defined by a section of the softened portion 204 and a section of the hardened portion 202. The section of the softened portion 204 is a substantially tubular structure, and the section of the hardened portion 202 is a substantially cylindrical structure that is within the substantially tubular structure. As shown by FIG. 4, a cross-section of the tip portion 118 is substantially circular, with a smaller diameter than a diameter of the cross-section of the base portion 120. For example, the smaller diameter of FIG. 4, which is taken at a vertical mid-point of the tip portion 118, may be in a range of approximately 50% to approximately 70% of the diameter of the base portion 120. In particular, the smaller diameter may be approximately 60% of the diameter of the base portion 120. Thus, the tip portion 118 is a substantially conical structure. Other shapes of the tool 112 are possible.

As indicated above, FIGS. 2-4 are provided as an example. Other examples may differ from what was described in connection with FIGS. 2-4. For example, cross-sectional shapes of the hardened portion 202 and the softened portion 204 may differ significantly in order to form tip portion geometries of different tools (e.g., a moil point, a chisel, a cutter, a wedge, and/or the like). In other words, in practice, different tools may be used in different contexts. These different tools may have different tip portion geometries, which may be formed using different cross-sectional shapes of the hardened portion 202 and the softened portion 204.

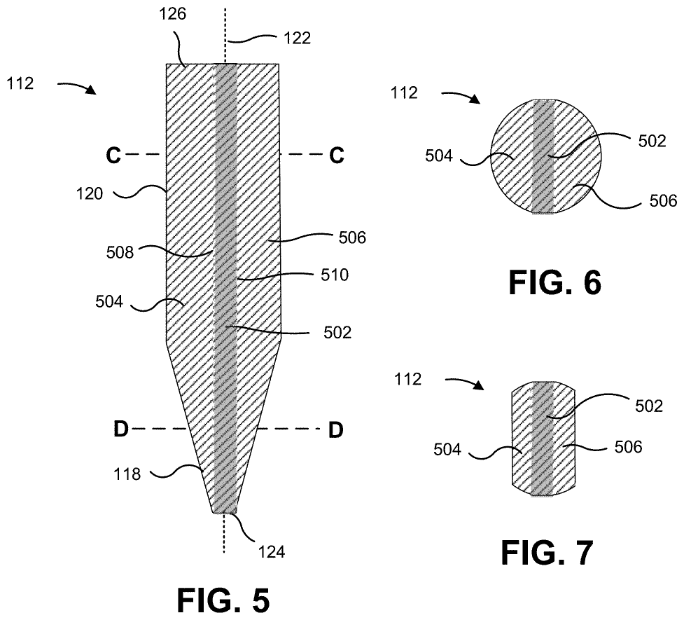

FIGS. 5-7 are diagrams of the tool 112 according to one or more aspects of the present disclosure. FIG. 5 is a diagram showing an axial cross-sectional view of the tool 112. FIG. 6 is a diagram showing a radial cross-sectional view of the tool 112, taken along line C-C of FIG. 5. FIG. 7 is a diagram showing a radial cross-sectional view of the tool 112, taken along line D-D of FIG. 5.

As shown in FIGS. 5-7, the tool 112 has the same, monolithic material and a similar structure to that of FIGS. 2-4. In particular, the tool 112 includes a hardened portion 502 that extends along and encompasses the longitudinal axis 122 of the tool 112 between the base end 126 and the tip end 124 of the tool 112. However, in contrast to FIGS. 2-4, which includes only the softened portion 204, the tool 112 further includes a first softened portion 504 and a second softened portion 506. The first softened portion 504, which extends along and is offset from the longitudinal axis 122, is adjacent to a first side 508 of the hardened portion 502. The second softened portion 506, which extends along and is offset from the longitudinal axis 122, is adjacent to a second side 510 of the hardened portion 502. Similar to that described with respect to FIGS. 2-4, the first softened portion 504, the second softened portion 506, and/or the hardened portion 502 may define a hardness gradient in the material, such that an exterior of the tool 112 is softer than an interior of the tool 112.

As shown by FIG. 6, a cross-section of the base portion 120 is substantially circular. Thus, the base portion 120 is a substantially cylindrical structure that is defined by a section of the first softened portion 504, a section of the second softened portion 506, and a section of the hardened portion 502. The section of the first softened portion 504 and the section of the second softened portion 506 are substantially semi-cylindrical structures. The section of the hardened portion 502 is a substantially rectangular prismatic structure that is between the substantially semi-cylindrical structures.

As shown by FIG. 7, a cross-section of the tip portion 118 has a smaller width than a width of the cross-section of the base portion 120. For example, the smaller width of FIG. 7, which is taken at a vertical mid-point of the tip portion 118, may be in a range of approximately 50% to approximately 70% of the width of the base portion 120. In particular, the smaller width may be approximately 60% of the width of the base portion 120. Thus, the tip portion 118 is a substantially triangular prismatic structure. Other shapes of the tool 112 are possible.

As indicated above, FIGS. 5-7 are provided as an example. Other examples may differ from what was described in connection with FIGS. 5-7. For example, cross-sectional shapes of the hardened portion 502, the first softened portion 504, and the second softened portion 506 may differ significantly in order to form tip portion geometries of different tools (e.g., a moil point, a chisel, a cutter, a wedge, and/or the like). In other words, in practice, different tools may be used in different contexts. These different tools may have different tip portion geometries, which may be formed using different cross-sectional shapes of the hardened portion 502, the first softened portion 504, and the second softened portion 506.

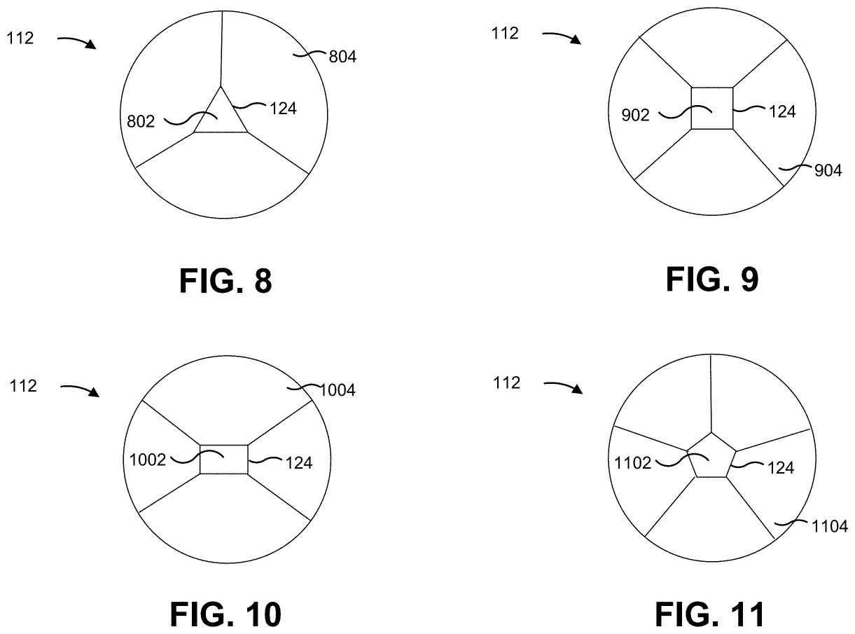

FIGS. 8-11 are bottom views of the tool according to one or more aspects of the present disclosure. The tool 112 of FIGS. 8-11 has the same, monolithic material and substantially the same structure as the tool 112 of FIGS. 2-4. FIG. 8 is a diagram of the tool 112 having a hardened portion 802 encompassed by a softened portion 804. In this example, the tip end 124 has a substantially triangular shape. Thus, the hardened portion 802 has a substantially triangular prismatic structure. FIG. 9 is a diagram of the tool 112 having a hardened portion 902 encompassed by a softened portion 904. In this example, the tip end 124 has a substantially square shape. Thus, the hardened portion 902 has a substantially square prismatic structure. FIG. 10 is a diagram of the tool 112 having a hardened portion 1002 encompassed by a softened portion 1004. In this example, the tip end 124 has a substantially rectangular shape. Thus, the hardened portion 1002 has a substantially rectangular prismatic structure. FIG. 11 is a diagram of the tool 112 having a hardened portion 1102 encompassed by a softened portion 1104. In this example, the tip end 124 has a substantially pentagonal shape. Thus, the hardened portion 1102 has a substantially pentagonal prismatic structure. Other shapes of the tool 112 are possible.

As indicated above, FIGS. 8-11 are provided as an example. Other examples may differ from what was described in connection with FIGS. 8-11. For example, shapes of the hardened portion 802, 902, 1002, 1102 and the softened portion 804, 904, 1004, 1104 may differ significantly in order to form tip portion geometries of different tools (e.g., a moil point, a chisel, a cutter, a wedge, and/or the like). In other words, in practice, different tools may be used in different contexts.

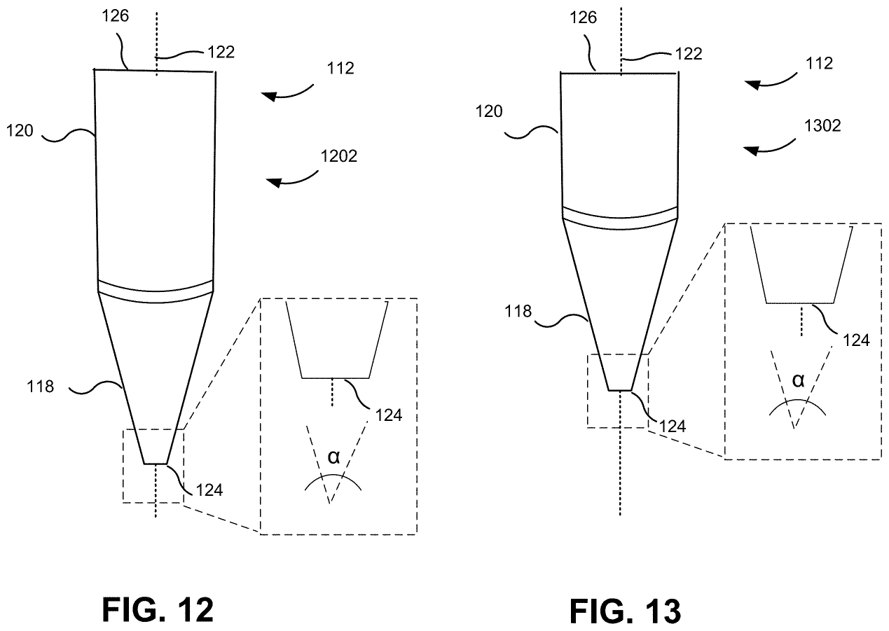

FIGS. 12-13 are diagrams of the tool 112 in various sharpened states. FIG. 12 is a diagram of a first sharpened state 1202 of the tool 112. FIG. 13 is a diagram of a second sharpened state 1302 of the tool 112 after a period of use. To simplify explanation, use of the tool 112 of FIGS. 2-4 will be described below. However, it should be understood that the tool 112 of FIGS. 5-11, or a similar tool not specifically illustrated, may remain sharp according to the same principles.

When using the tool 112 to penetrate an object (e.g., a rock, concrete, asphalt, ground, or other material), a control system of the machine 100 positions the tool 112 such that the longitudinal axis 122 is substantially perpendicular to a surface of the object. To position the tool 112, the control system moves the boom 104, the stick 106, and the hammer driver 110, which are pivotably attached to one another. With the tip end 124 of the tool 112 contacting the surface, the hammer driver 110 applies a downward force on the tool 112 to strike the surface of the object. Because the hardness of the softened portion 204 is lower than the hardness of the hardened portion 202, the softened portion 204 is configured to erode faster than the hardened portion 202. Due to the symmetrical shape of the tip portion 118, each penetrating strike of the tool 112 against the object causes the softened portion 204 of the tip portion 118 to symmetrically abrade away. As the tip portion 118 wears away over time, the taper angle α of the tip portion 118 remains substantially constant as the base portion 120 shortens along the longitudinal axis 122. Thus, the tool 112 is configured to not only withstand forces involved in demolition and excavation, but to maintain sharpness over time.

As indicated above, FIGS. 12-13 are provided as an example. Other examples may differ from what was described in connection with FIGS. 12-13.

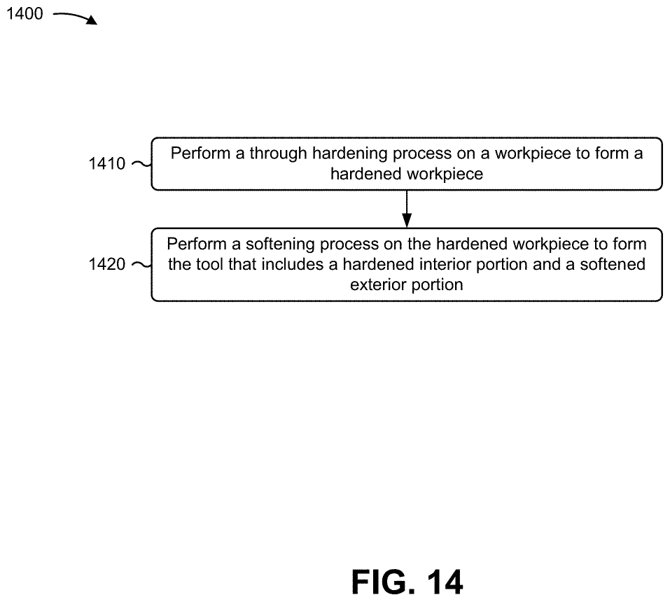

FIG. 14 is a flowchart of an example method 1400 of manufacturing the tool. The method 1400 begins with preliminarily forming, from a single, monolithic piece of bar stock (e.g., made of steel or a similar type of metal), a workpiece by a machining process. The machining process, which may include cutting, grinding, polishing, or a combination thereof, shapes the bar stock into the workpiece. The workpiece may have a base portion and a tip portion, which are shaped to form a moil point, a chisel, a cutter, a wedge, and/or the like. The tip portion may be tapered from the base portion to a tip end to define a taper angle of the tip portion.

As shown in FIG. 14, once the workpiece is formed, the method 1400 includes performing a through hardening process on the workpiece to form a hardened workpiece (block 1410). The through hardening process comprises a furnace hardening process. The furnace hardening process involves using electrical heating elements or combustion of hydrocarbon gases to heat the workpiece to at least 800 degrees Celsius for a hardening time period. The hardening time period may depend on properties of the workpiece, such as a material of the workpiece, a size of the workpiece, and a shape of the workpiece. To obtain a desired hardness (e.g., in a range from approximately 44 HRC to approximately 55 HRC on the Rockwell scale), the workpiece is rapidly cooled to approximately room temperature by a method such as quenching in water or oil. Using a controlled environment, the furnace hardening process is configured to yield consistent, repeatable results.

As further shown in FIG. 14, the method 1400 includes performing a softening process on the hardened workpiece to form the tool that includes a hardened interior portion and a softened exterior portion (block 1420). The softening process comprises an induction tempering process. The induction tempering process involves using an electromagnetic field to selectively reheat an exterior of the hardened workpiece to be in a range from approximately 425 degrees Celsius to approximately 650 degrees Celsius for a softening time period. The softening time period may depend on properties of the workpiece, such as a material of the workpiece, a size of the workpiece, and a shape of the workpiece. To obtain a desired hardness (e.g., in a range from approximately 28 HRC to approximately 32 HRC on the Rockwell scale) and a desired shape of the softened exterior portion of tool, the induction tempering process further involves setting various parameters, such as distance to the hardened workpiece, coil shape, and temperature. After the exterior of the hardened workpiece is heated for the softening time period, the hardened workpiece is cooled to reduce a temperature of the hardened workpiece. Using a controlled environment, the induction tempering process is configured to yield consistent, repeatable results.

Because softer material wears faster than harder material, the softening process may be used to form a preferential wear pattern in the hardened workpiece. In some examples, the softening process may involve setting fixed parameters to create a hardness gradient in the softened exterior portion and/or the hardened interior portion. In these examples, because the exterior is closest to a heat source used in the softening process, the exterior of the tool may be softer than an interior of the tool.

In some examples, the softening process may involve altering parameters to achieve a desired wear pattern. In these examples, the softening process may involve performing the softening process on a first section of the hardened workpiece in a first manner (e.g., for a first duration of time, at a first temperature setting, and/or using another parameter). The softening process may further involve performing the softening process on a second section of the hardened workpiece in a second manner (e.g., for a second duration of time, at a second temperature setting, and/or using another parameter). The second section may be different than the first section (e.g., by having different dimensions of the hardened interior portion and/or the softened exterior portion), and the second manner may be different than the first manner. By altering the parameters during the softening process, the tool may have a wear pattern that promotes greater retention of the taper angle of the tip portion over time.

In some implementations, the softening process occurs immediately after the hardening process to complete the tool. In some implementations, the softening process may be delayed (e.g., for days, weeks, or years) after the hardening process due to performance of an intermediate process. The intermediate process may include induction tempering to reheat the hardened workpiece to be in a range from approximately 150 degrees Celsius to approximately 200 degrees Celsius. After the hardened workpiece is cooled, the hardened workpiece may be set aside and softened according to the softening process when desired. Thus, the intermediate process, by increasing toughness of the hardened workpiece, may improve flexibility in the method of manufacturing the tool.

Although FIG. 14 shows example blocks of the method 1400, in some implementations, the method 1400 may include additional blocks, fewer blocks, different blocks, or differently arranged blocks than those depicted in FIG. 14. Additionally, or alternatively, two or more of the blocks of the method 1400 may be performed in parallel.

### INDUSTRIAL APPLICABILITY

The tool 112 of the present disclosure is particularly applicable in a power hammer, such as a hydraulic hammer, a pneumatic hammer, a breaker, or another device that involves a downward application of force to break apart an object. The power hammer, which may perform work associated with a particular industry, such as construction, mining, agriculture, waste management, material handling, or forestry, may be part of an excavator, a backhoe loader, a skid steer loader, a dozer, a motor grader, a jackhammer, or another type of machine.

Because other tools may include hardened exterior surfaces extending at an angle relative to a direction of force, the other tools may be susceptible to bending and/or breaking. In contrast to the hardened exterior surfaces of the other tools, the hardened portion 202, 502, 802, 902, 1002, 1102 of the tool 112 extends parallel to a direction of force and is encompassed by the softened portion 204, 804, 904, 1004, 1104 and/or substantially covered by the first softened portion 504 and the second softened portion 506. Thus, the hardened portion 202, 502, 802, 902, 1002, 1102 provides additional strength to the tool 112 and is protected from direct contact with the objects. In further contrast to the other tools, the tip end 124 is configured to remain sharp as the tool 112 is driven into the objects. Because of this combination of features (e.g., strength and sharpness retention), the tool 112 has a number of benefits, including an extended service life, reduced costs, and improved user experience.

As used herein, the articles “a” and “an” are intended to include one or more items, and may be used interchangeably with “one or more.” Also, as used herein, the terms “has,” “have,” “having,” or the like are intended to be open-ended terms. Further, the phrase “based on” is intended to mean “based, at least in part, on.”

The foregoing disclosure provides illustration and description, but is not intended to be exhaustive or to limit the implementations to the precise form disclosed. Modifications and variations may be made in light of the above disclosure or may be acquired from practice of the implementations. It is intended that the specification be considered as an example only, with a true scope of the disclosure being indicated by the following claims and their equivalents. Even though particular combinations of features are recited in the claims and/or disclosed in the specification, these combinations are not intended to limit the disclosure of various implementations. Although each dependent claim listed below may directly depend on only one claim, the disclosure of various implementations includes each dependent claim in combination with every other claim in the claim set.

What is claimed is:

1. A tool for a machine implement, the tool comprising:
a hardened portion of a material, wherein the hardened portion extends along and encompasses a longitudinal axis of the tool between a base end and a tip end of the tool; and
a softened portion of the material, wherein the softened portion extends along and is offset from the longitudinal axis of the tool between the base end and the tip end of the tool.

2. The tool of claim 1, wherein the hardened portion is formed from the material being hardened during a hardening process, and
wherein the softened portion is formed from an exterior of the material being softened after the hardened portion was hardened during the hardening process.

3. The tool of claim 1, wherein the hardened portion and the softened portion together define a hardness gradient of the tool, such that a measure of hardness of an exterior of the tool is less than a measure of hardness of an interior of the tool.

4. The tool of claim 1, wherein the softened portion is configured to erode, during use of the tool, faster than the hardened portion.

5. The tool of claim 1, wherein the hardened portion and the softened portion together define a base portion of the tool and a tip portion of the tool,
wherein the tip portion is tapered from the base portion to the tip end to define a taper angle of the tip portion, and
wherein, during use, the taper angle of the tip portion remains substantially constant as the base portion shortens along the longitudinal axis.

6. The tool of claim 1, wherein a section of the softened portion is a tubular structure, and a section of the hardened portion is a cylindrical structure that is within the tubular structure.

7. The tool of claim 1, wherein the hardened portion is a substantially cylindrical structure.

8. The tool of claim 1, wherein the softened portion is a first softened portion,
wherein the first softened portion is adjacent to a first side of the hardened portion; and
wherein the tool further comprises a second softened portion,
wherein the second softened portion extends along and is offset from the longitudinal axis of the tool between the base end and the tip end of the tool, and
wherein the second softened portion is adjacent to a second side of the hardened portion.

9. The tool of claim 1, wherein the hardened portion is a substantially rectangular prismatic structure.

10. The tool of claim 1, wherein the material comprises a single, monolithic piece of steel.

11. A method of manufacturing a tool for a machine implement, the method comprising:
performing a through hardening process on a workpiece to form a hardened workpiece; and
performing a softening process on the hardened workpiece to form the tool that includes a hardened interior portion and a softened exterior portion.

12. The method of claim 11, wherein prior to performing the through hardening process, the workpiece is formed from a steel material by a machining process.

13. The method of claim 11, wherein the through hardening process comprises a furnace hardening process, and the softening process comprises an induction tempering process.

14. The method of claim 11, wherein the hardened interior portion is at least one of a substantially cylindrical structure, a substantially triangular prismatic structure, a substantially square prismatic structure, a substantially rectangular prismatic structure, or a substantially pentagonal prismatic structure.

15. The method of claim 11, wherein the through hardening process involves heating the workpiece to at least 800 degrees Celsius for a hardening time period, and
wherein the softening process involves causing an exterior of the hardened workpiece to be in a range from approximately 425 degrees Celsius to approximately 650 degrees Celsius for a softening time period.

16. The method of claim 11, wherein performing the softening process comprises:
setting a first parameter of the softening process;
performing the softening process, based on the first parameter, at a first section of the tool;
altering the first parameter into a second parameter; and
performing the softening process, based on the second parameter, at a second section of the tool to cause a dimension of the softened exterior portion at the first section of the tool to be different than a dimension of the softened exterior portion at the second section of the tool.

17. The method of claim 11, wherein performing the softening process comprises:
performing the softening process on a first section of the hardened workpiece in a first manner; and
performing the softening process on a second section of the hardened workpiece in a second manner that is different from the first manner,
wherein dimensions of the hardened interior portion and the softened exterior portion of the tool at the first section are different from corresponding dimensions at the second section.

18. The method of claim 17, wherein the first manner is different from the second manner based on at least one of:
varying a duration of time associated with performing the softening process, or
varying a temperature setting of the softening process.

19. A hammer implement for a machine, the hammer implement comprising:
a hammer driver; and
a replaceable tool that is to be driven by the hammer driver, the replaceable tool comprising:
a softened exterior portion of a material; and
a hardened interior portion of the material, wherein the hardened interior portion is:
coaxially aligned with the softened exterior portion; and
situated within the softened exterior portion between a base end and a tip end of the replaceable tool.

20. The hammer implement of claim 19, wherein the softened exterior portion is configured to wear faster than the hardened interior portion.
